(19) United States
(12) Patent Application Publication
(10) Pub. No.: US 2020/0368997 A1
(43) Pub. Date: Nov. 26, 2020

(54) COMPOSITE STRUCTURES FOR LOCALIZED STIFFENING

(71) Applicant: Zephyros, Inc., Romeo, MI (US)

(72) Inventors: Jeffrey Bradley, Romeo, MI (US); Dean Quaderer, Romeo, MI (US); Chris Hable, Romeo, MI (US); Steve Regan, Romeo, MI (US); Kyle Royston, Romeo, MI (US)

(21) Appl. No.: 16/635,350

(22) PCT Filed: Sep. 13, 2018
(86) PCT No.: PCT/US2018/050961

§ 371 Date: Jan. 30, 2020

Related U.S. Application Data
(60) Provisional application No. 62/558,324, filed on Sep. 13, 2017.

(51) Int. Cl. B32B 5/02; B32B 5/10; B32B 5/16; B32B 5/30; B32B 5/20; B62D 29/04; B60J 5/04

(52) U.S. Cl. CPC B32B 5/028; B32B 2255/20; B32B 5/16; B32B 5/30; B32B 5/20; B62D 29/043; B60J 5/0451; B32B 2605/00; B32B 2255/02; B32B 2255/26; B32B 2262/0269; B32B 2262/106; B32B 2262/101; B32B 2264/101; B32B 2264/303; B32B 2307/544; B32B 2607/00; B32B 2556/00; B32B 2405/00; B32B 5/10

(57) ABSTRACT

A reinforcing device comprising a composite reinforcing patch including a first layer comprising a first activatable material that is flexible and tacky in its green state prior to activation, a second layer comprising a stabilizing material selected from a mesh, a film, a chemical coating, a fibrous or spherical material, or a second activatable material located in planar contact with the activatable material and along the entirety of a first surface of the activatable material, and an optional third layer comprising a mesh, a film, a chemical coating, second activatable material, or a release paper located in planar contact with the activatable material and along the entirety of a surface of the first layer or second layer, wherein upon activation of the activatable material, the presence of the second layer, the optional third layer, or both provides dimensional stability to the activatable material and minimizes shrinking of the activatable material.

### TECHNICAL FIELD

The present teachings relate generally to a composite stiffening patch that includes multiple layers including at least one activatable material layer, at least one stabilizing layer and an optional film or coating layer for providing localized stiffening to a panel surface.

### BACKGROUND

The transportation industry continues to require methods of reinforcement that minimize production time and installation time while improving the strength of reinforcement provided and providing simplified customization of product shape and configuration. There is thus a need in the art of reinforcement for high-strength reinforcing materials that can be easily (and possibly robotically) added to a vehicle panel for localized reinforcement with no additional fastening steps. There is a further need for reinforcing materials that can be easily cut to a desired shape and size without the need for molds or additional forming steps. There is also a further need to be able to efficiently and effectively handle the reinforcing materials while in a green state (e.g. prior to activation).

### SUMMARY OF THE INVENTION

In a first aspect the present teachings contemplate a reinforcing device comprising: a composite reinforcing patch including, a first layer comprising a first activatable material that is flexible and tacky in its green state, a second layer comprising a stabilizing material selected from a mesh, a film, a chemical coating, a fibrous or spherical material, or a second activatable material located in planar contact with the activatable material and along the entirety of a first surface of the activatable material, and an optional third layer comprising a mesh, a film, a chemical coating, second activatable material, or a release paper located in planar contact with the activatable material and along the entirety of a surface of the first layer or second layer. Upon activation of the activatable material, the presence of the second layer, the optional third layer, or both provides dimensional stability to the activatable material and minimizes shrinking of the activatable material.

The device may include one or more secondary composite reinforcing patches that are located into direct contact with the composite reinforcing patch. The one or more secondary composite reinforcing patches may include a first layer comprising an activatable material and a second layer comprising a stabilizing material.

Prior to activation of the activatable material, the device may be sufficiently flexible to conform to the shape of a vehicle panel. After activation of the activatable material, the device may continue to conform to the shape of a vehicle panel but is no longer flexible. After activation of the activatable material, the device may be rigid. The device may be capable of bending without breaking prior to activation of the activatable material. The device may bend under its own weight when held at its end prior to activation of the activatable material. The composite reinforcing patch may cover a significant portion of an automotive panel (e.g., more than 25% of the panel, or more than 50% of the panel). The one or more secondary composite reinforcing patches may cover only select portions of the composite reinforcing patch where additional reinforcement is required on an automotive panel.

The activatable material may be activated to expand and the volumetric expansion of the activatable material is at least about 100% and less than about 300% relative to its size in the green state (e.g., prior to activation). The activatable material may be a structural adhesive material. The activatable material may be a sealant material. The stabilizing material may be an open mesh having an open area of at least 50 percent of a total surface area of the device. The stabilizing material may be a fibrous material located within and/or onto activatable material. The stabilizing material may be a material blended into the activatable material and selected from glass fibers, carbon fibers, aramid fibers, glass microspheres, or any combination thereof. The second layer or optional third layer may be a film is adapted so that polymerization begins to occur at the time the device contacts a surface of a vehicle panel. The weight of the composite stiffening patch is sufficiently low to avoid slipping of the device prior to or during activation of the activatable material.

The device may include a third layer wherein the third layer is a coating located onto the stabilizing layer. The coating may include a hydroxide component selected from magnesium hydroxide, aluminum hydroxide, sodium hydroxide, or some combination thereof. The coating may include an acetate or acrylate selected from polyvinyl acetate, ethylene vinyl acetate, ethylene methyl acrylate, ethyl acrylate, or combinations thereof. The stabilizing layer may be an open mesh and the open mesh is coated with the third layer. The coating may include a hydroxide component selected from magnesium hydroxide, aluminum hydroxide, sodium hydroxide, or some combination thereof. The coating may include an acetate or acrylate selected from polyvinyl acetate, ethylene vinyl acetate, ethylene methyl acrylate, ethyl acrylate, or combinations thereof.

The device may be adapted to receive a surface treatment to facilitate robotic handling and installation of the device. One or more layers of the device may include a magnetic component. Multiple composite reinforcing patches may be cut from a large sheet of composite stiffening patch. The stabilizing layer may be a second activatable material that has a volume expansion of at least about 200% as compared to its size in the green state prior to activation. The glass transition temperature of the activatable material may be within 20° C. of ambient temperature.

The teachings herein are further directed to a method for structurally reinforcing a vehicle body stamping comprising forming a tacky activatable adhesive material, locating a stabilizing material onto or into the activatable adhesive material to form a composite stiffener, applying a handling layer to the composite stiffener, and cutting the composite stiffener to form one or more composite stiffening patches.

The method may further include robotically retrieving the one or more composite stiffening patches and robotically locating the one or more composite stiffening patches onto a surface of the vehicle body stamping surface. The method may include activating the activatable adhesive material to expand by application of heat, wherein the composite stiffening patch remains in contact with the stamping surface by means of the tacky nature of the activatable adhesive material prior to activating the activatable adhesive material, the handling film, or both.

The method may be free of any separate fastening step for connecting the composite stiffening patch to the body stamping surface. The method may include flexing the composite stiffening patch to conform to the shape of the body stamping prior to activating the activatable adhesive material. The method may include cutting the composite stiffener after locating the stabilizing material into or onto the activatable adhesive material. The method may include cutting the activatable adhesive material before locating the stabilizing material into or onto the activatable adhesive material. The method may include locating a secondary composite stiffening patch into contact with the composite stiffening patch. The method may include cutting the composite stiffening patch to a desired shape prior to contact with the vehicle body stamping surface.

The step of forming the activatable adhesive material may be free of any molding process. The step of locating the stabilizing material onto the activatable adhesive material may be free of any separate fastening step for connecting the stabilizing material to the activatable adhesive material. The step of activating the activatable adhesive material includes volumetric expansion of at least about 100% and less than about 300% as compared to the material in its green state prior to activation. The method may include flexing the composite stiffening patch so that a first portion of the composite stiffening patch is arranged at an angle of 90° or less from a second portion of the composite stiffening patch. The method may include flexing the composite stiffening patch so that a surface of the vehicle body stamping is contacted by the composite stiffening patch that would not be contacted by the composite stiffening patch if the composite stiffening patch were substantially rigid.

The stabilizing material may be located onto the activatable adhesive so that the activatable material substantially covers at least one surface of the stabilizing material and is free of any voids on the stabilizing material that are not covered with the activatable adhesive prior to activation. The composite stiffening patch may be no longer flexible after activation of the activatable adhesive material. The vehicle body stamping may be a vehicle door panel. The composite stiffening patch may be located adjacent a vehicle door handle.

The teachings herein contemplate a device and method for the structural reinforcement of body stampings with a first and at least one secondary reinforcing patch devices. One or more of the first and secondary reinforcing devices may include activatable structural adhesive material and associated open mesh and a handling layer. The device disclosed herein may allow for effective reinforcing of a cavity where little or no additional fastening steps or fastening means are required.

### BRIEF DESCRIPTION OF THE DRAWINGS

FIG. 1 shows an exemplary device in accordance with the present teachings show located on a vehicle door panel.

FIGS. 2A-2D show various embodiments of exemplary devices in accordance with the present teachings.

FIG. 3 shows an additional embodiment of an exemplary device in accordance with the present teachings.

FIGS. 4A-4D show additional embodiments of the devices of FIG. 2A, 2C, 2D and FIG. 3, respectively.

FIG. 5 shows an additional embodiment of exemplary devices in accordance with the present teachings.

FIGS. 6A and 6B depict an exemplary installation of the device in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 62/558,324, filed Sep. 13, 2017, the contents of that application being incorporated by reference herein for all purposes. This application is also related to U.S. Publication No. 2014/0134905, which is incorporated by reference herein for all purposes.

The first layer of the composite stiffening patch as described in the present teachings includes an activatable material (e.g., an activatable adhesive material) that is at least partially tacky at room temperature (e.g., at about 23° C.) and also may be tacky at temperatures between about 0° C. and about 80° C. The second layer of the composite stiffening patch may also include an activatable material. Additionally, the activatable material preferably exhibits reinforcement characteristics (e.g., imparts rigidity, stiffness, strength or a combination thereof to a member). It is also preferable for the activatable material to be heat activated to expand or otherwise activate and wet surfaces which the activatable material contacts. After expansion or activation, the activatable material preferably cures, hardens and adheres to the surfaces that it contacts. For application purposes, it is often preferable that the activatable material exhibit flexibility, particularly when the activatable material is to be applied to a contoured surface of a vehicle body. Once applied, however, it is typically preferable for the activatable material to be activatable to soften, expand (e.g., foam), cure, harden or a combination thereof. For example, and without limitation, a typical activatable material will include a polymeric material, such as an epoxy resin or ethylene-based polymer which, when compounded with appropriate ingredients (typically a blowing and curing agent), expands and cures in a reliable and predicable manner upon the application of heat or the occurrence of a particular ambient condition. The activatable material may also be substantially free of any ethylene based copolymers. From a chemical standpoint for a thermally-activated material, the activatable material may be initially processed as a flowable material before curing. Thereafter, the base material preferably cross-links upon curing, which makes the material substantially incapable of further flow.

The activatable material may include a variety of polymeric materials. The activatable material may include one or more epoxy-based materials that may be thermoplastic epoxies or thermoset epoxies. The activatable material may include one or more agents to act as a toughener. The toughener may include a polymeric particle dispersed in an epoxy resin. The activatable material may include one or more mineral reinforcements.

The epoxy may be aliphatic, cycloaliphatic, aromatic or the like. The epoxy may be supplied as a solid (e.g., as pellets, chunks, pieces or the like) or a liquid. The epoxy may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. One exemplary epoxy resin may be a phenolic resin, which may be a novolac type or other type resin. Other preferred epoxy containing materials may include a bisphenol-A epichlorohydrin ether polymer, or a bisphenol-A epoxy resin which may be modified with butadiene or another polymeric additive. The resin may be a phenoxy resin. The activatable material can include up to about 50% by weight epoxy resins, more preferably, up to about 65% by weight epoxy resins, and even more preferably up to about 80% by weight epoxy resins.

A substantial portion of the components in the activatable material will typically have molecular weights that are low enough to maintain adhesive capability of the base material. For an elastomer-based or epoxy-based base material, it is preferable for at least about 5% by weight of the elastomer or epoxy materials to have a molecular weight less than about 1000 and more preferably at least about 10% by weight of the elastomer or epoxy materials have a molecular weight less than about 1000. It is also contemplated that, for maintaining adhesive capability, components such as plasticizers or processing oils may be added to elastomer-based or epoxy-based materials and particularly to the thermoplastic-based activatable material.

As general guidance for the activatable material, it is preferable that at least 1% by weight of the components have a low enough molecular weight to be a liquid at about 23° C. More preferably, at least 5% by weight of the components have a low enough molecular weight to be a liquid at about 23° C. Still more preferably, at least 10% by weight of the components have a low enough molecular weight to be a liquid at about 23° C.

In most applications, it is undesirable for the activatable material to be reactive at room temperature or otherwise at the ambient temperature in a manufacturing environment (e.g. up to about 40° C. or higher). More typically, the activatable material becomes reactive at higher processing temperatures, such as those encountered in an automobile assembly plant. In such and embodiment, the activatable material may be foamed upon automobile components at elevated temperatures or at higher applied energy levels, e.g., during painting preparation steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the base material to cause expansion at different temperatures outside the above ranges. Generally, suitable activatable materials or foams for the activatable material have a range of expansion ranging from approximately 0 to over 1000 percent.

Advantageously, the activatable material of the present teachings may be formed or otherwise processed in a variety of ways. For example, activatable materials can be processed by injection molding, extrusion, compression molding or with a robotically controlled extruder such as a mini-applicator. This enables the formation and creation of part designs that exceed the capability of most prior art materials. Formation of the activatable materials as described herein may also be free of any molding step. The activatable materials may be extruded or may be co-extruded with one of the second or third layer of the composite stiffening patch as described herein.

The activatable material is preferably tacky in its green or un-activated state. The activatable material may be sufficiently tacky so that no additional fastener is required to attach the composite stiffening patch. The activatable material may be sufficiently tacky so that the composite stiffening patch does not slide or slip from a location on a panel prior to activation. The activatable material should remain tacky at a wide temperature range both below and above ambient temperature to accommodate varying environmental conditions during installation and prior to activation.

The stabilizing material as described herein may include one or more of a mesh, a film, a chemical coating, a fibrous or spherical material, or a second activatable material. In the event that the stabilizing material comprises a mesh material, an open mesh may be utilized that is at least partially open or has through-holes. It is possible that the open portion is at least about 25 percent of the area of the composite stiffening patch, more preferably at least about 40 percent, and most preferably at least about 50 percent, but less than about 90 percent. It is contemplated that the amount of area of the open portion be as high as possible while allowing the complete assembly to maintain its desired structural performance and physical properties.

The stabilizing material layer located onto or mixed into the activatable material may include non-conductive threads or wire (e.g., elongated filament, fibrous, or fabric material), which may be applied as a film, a mat, a cloth, a roving, a netting, a mesh, a scrim, or the like. The stabilizing material may be composed, for example, of woven or unwoven fibers, chopped fibers filaments or the like of cotton, glass (e.g., E-glass or S-glass), fiberglass, Mylar, Nylon, polyester, carbon, aramid, plastics, polymers (e.g., thermoplastics such as polyamides (e.g., nylon), PET (e.g., Mylar), polycarbonate, polyethylene, polypropylene, polybutylene (e.g., polybutylene terephthalate), polystyrene, polyurethane, vinyl, or any combination thereof, or other materials. As used herein, “threads,” or “wire” connotes a single filament of material, a braided bundle of filaments, or an unbraided bundle of filaments.

The stabilizing layer may include or may be coated with a coating material. The coating may include a hydroxide component selected from magnesium hydroxide, aluminum hydroxide, sodium hydroxide, or some combination thereof. The coating may include an acetate or acrylate selected from polyvinyl acetate, ethylene vinyl acetate, ethylene methyl acrylate, ethyl acrylate, or combinations thereof. The stabilizing layer may be an open mesh and the open mesh is coated with the third layer. The coating may include a hydroxide component selected from magnesium hydroxide, aluminum hydroxide, sodium hydroxide, or some combination thereof. The coating may include an acetate or acrylate selected from polyvinyl acetate, ethylene vinyl acetate, ethylene methyl acrylate, ethyl acrylate, or combinations thereof. The coating may be received by a mesh material. The coating may be received by a fiberglass mesh material.

It may appreciable that the stabilizing material layer may be bead-like particles, aggregates, hollow material (e.g., hollow particle), or otherwise, or any combination thereof. In such embodiments, the stabilizing material layer may be composed, for example, of particles or the like of glass (e.g., E-glass or S-glass), fiberglass, Nylon, polyester, carbon, aramid, plastics, polymers (e.g., thermoplastics such as polyamides (e.g., nylon), polycarbonate, polyethylene, polypropylene, polybutylene (e.g., polybutylene terephthalate), polystyrene, polyurethane, vinyl, or any combination thereof), or other materials.

The stabilizing layer or the third optional layer may comprise a film, which may include a handling film or a release paper. The optional third layer may also comprise a mesh, a film, a chemical coating, second activatable material, or a release paper located in planar contact with the activatable material and along the entirety of a surface of the first layer or second layer. Any film layer (which may be referred to as a film/coating layer herein) may be located in planar contact with one or more of the additional layers, including the activatable material layer.

It should be understood that the film/coating layer may include a variety of layer formats including a film extrusion, a coating, or any deposition of a substance that assists in maintaining the dimensional stability of the activatable material prior to activation, minimizing shrinkage of the activatable material during activation, reducing read-through on the surface of the panel opposing the surface which receives the composite stiffening patch, minimizing slipping of the composite stiffening patch during use, reducing environmental effects on the composite stiffening patch, or any combination thereof.

It is contemplated that the film layer uses of a monomeric composition for coating a secondary material (e.g. the activatable material and/or the stabilizing layer). The monomeric composition may be a one-part material that polymerizes either immediately or at some later designated time at room temperature. It is quite possible that the monomeric composition polymerizes at room temperature without the addition of any initiator or stimulus. However, it is also possible that an initiator or stimulus may be utilized to cause polymerization of the composition. The composition may be such that the time of polymerization can be modified so that it is “on demand”. In other words, the composition can be applied as a coating to a secondary material and provide sufficient open time for application of the coating with no polymerization such that the composition does not polymerize until contact with a substrate a choice (e.g. the surface of the vehicle). Thus, open time for the application process can extend a number of minutes or even an hour without fear of early polymerization. It is possible that only contact with certain substrates initiates polymerization of the composition. Further details of one or more preferred embodiment of the handling film or layer may be found in U.S. patent provisional application No. 62/325818, filed on 21 Apr. 2016 and in U.S. patents documents U.S. Pat. Nos. 8,609,885; 8,884,051; and 9,181,365 and U.S. Publication Nos. 2014/0329980 and 2015/0056879 that may be relevant to the present teachings, and are all incorporated by reference for all purposes.

The composite stiffening patches described herein are intended to be utilized in a manner that makes them easily cut and installed (possibly robotically) to a size and location that is easily customizable by an end user. The composite stiffening patches may be stacked. The material for forming the composite stiffening patches may be entirely recycled and re-used so that any offal cut from a composite stiffening patch can be re-formed into a composite stiffening patch. A larger composite stiffening patch may be cut into a variety of shapes depending upon end user needs. A panel may receive one large composite stiffening patch that covers a significant portion of the panel, while smaller composite stiffening patch may be stacked onto the large patch where additional reinforcement is required.

The film layer may include an EVA (ethylene vinyl acetate) component. The film may include a thermoplastic epoxy component. The film may include a methacrylate component. The film may include a polyethylene component. The film may include a polypropylene component.

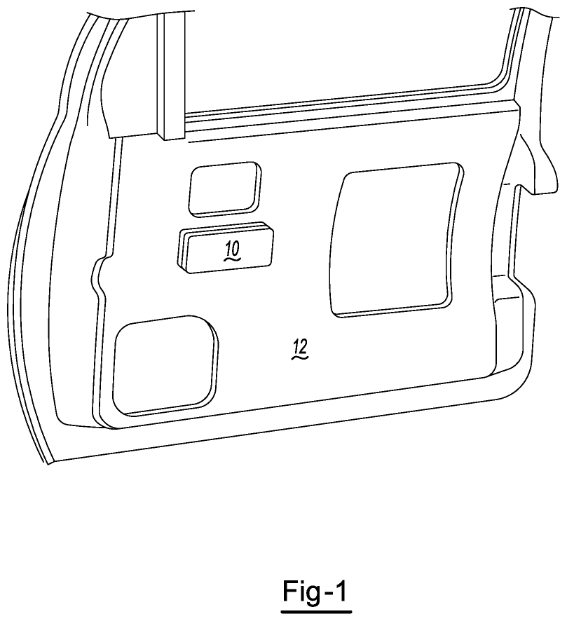

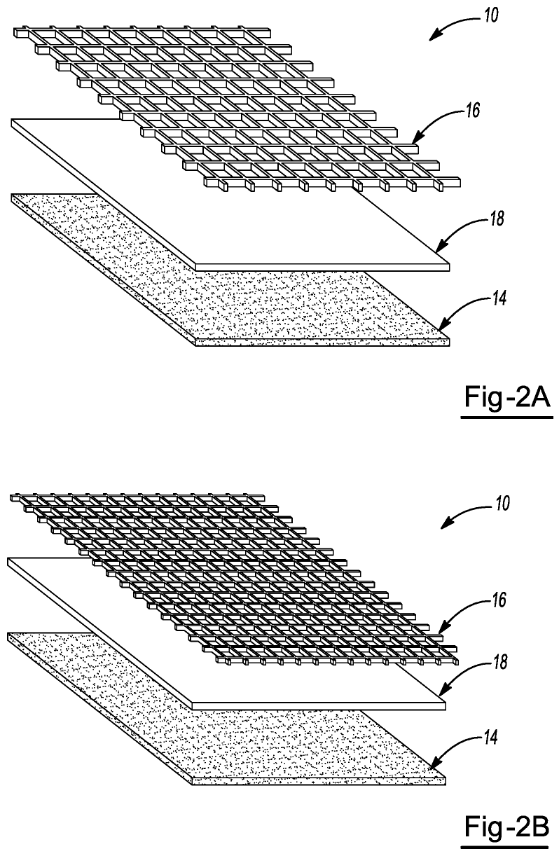

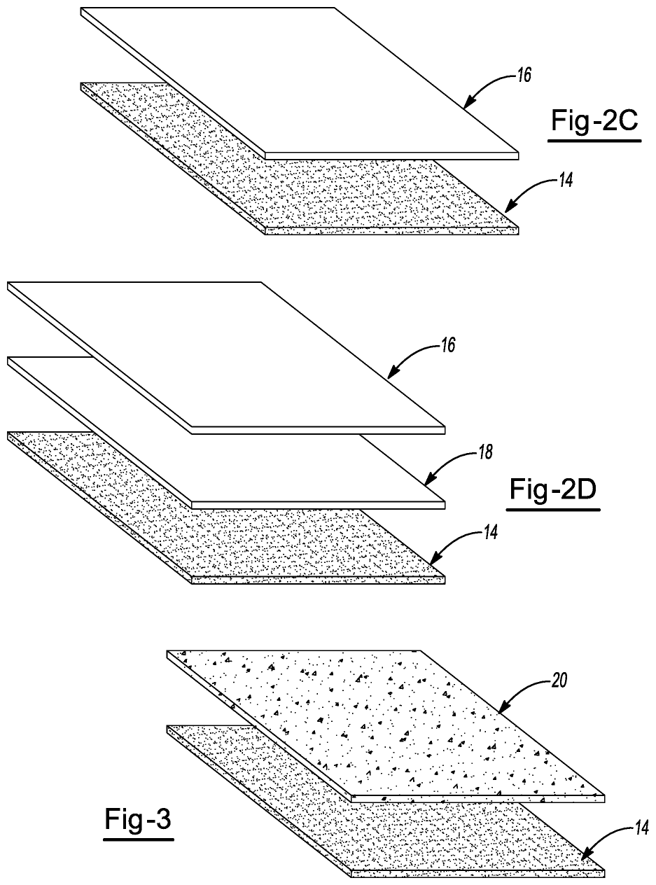

FIG. 1 shows the composite stiffening patch 10 located on a vehicle panel surface 12. FIG. 2A shows an embodiment of the present teachings showing an activatable material layer 14, a film/coating layer 18 and a stabilizing layer 16. It is quite possible that any layers depicted herein may be arranged in an order that is different from that depicted in the figures shown herein. For example, the film/coating layer 18 may be located directly onto the activatable material layer 14, or the film/coating layer 18 may be located on top of the stabilizing layer 16. The stabilizing layer 16 depicted in FIG. 2A is shown as an open mesh structure having relatively large openings in the mesh. In FIG. 2B, a similar structure is shown to that of 2A, wherein the composite stiffening patch 10 is shown to include an activatable material layer 14, a film/coating layer 18, and a stabilizing layer 16, however the stabilizing layer 16 is shown as a mesh with much smaller openings than that of FIG. 2A. FIG. 2C shows an embodiment of the present teachings wherein the activatable material layer 14 is substantially covered by a stabilizing layer 16. The stabilizing layer 16 may also be integrated within the activatable material 14, for example when the stabilizing layer comprises a fiber material that is mixed in with the activatable material layer 14. FIG. 2D shows an embodiment similar to that of FIG. 2C, only the device further includes the film/coating layer.

FIG. 3 depicts a further embodiment of the present teachings, where the activatable material layer 14 is arranged in a layered format with a second formulated layer, which may be a second activatable material layer 20.

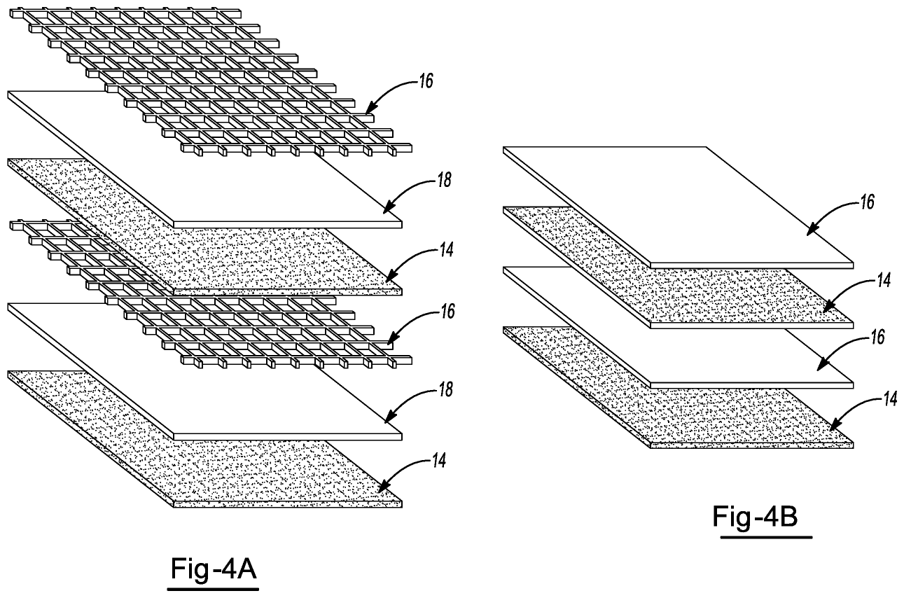

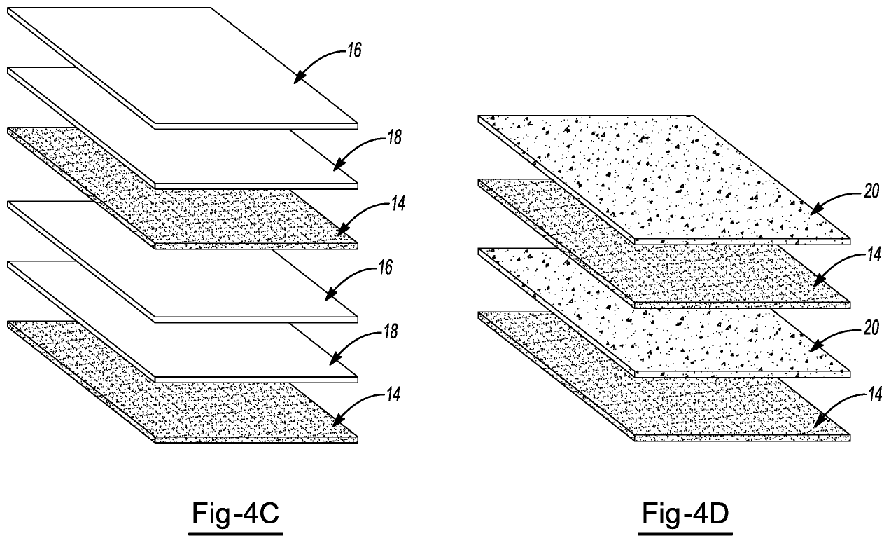

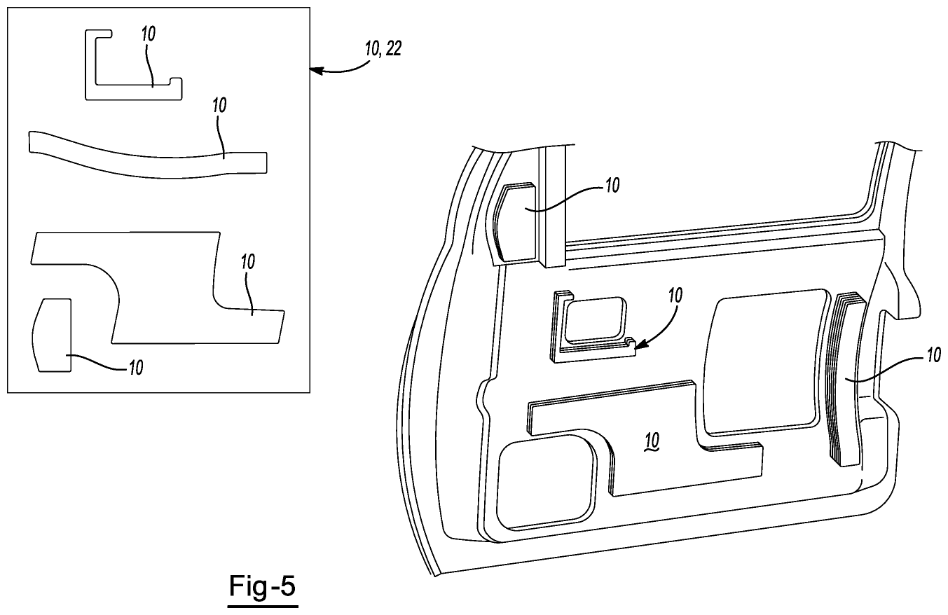

FIGS. 4A and 4B show exemplary devices of the present teachings wherein multiple composite stiffening patches are arranged in contact with one another. Specific to FIG. 4A, two composite stiffening patches similar to that shown in FIG. 2A are arranged in a stacked formation including two activatable material layers 14, two stabilizing layers 16 and two film/coating layers 18. FIG. 4B shows a stacked structure utilizing the composite stiffening patches as shown in FIG. 2C, including two activatable material layers 14 and two stabilizing layers 16. FIG. 4C depicts two stacked composite stiffening patches as those shown in FIG. 2D. While FIG. 4D depicts a stacked arrangement of two composite stiffening patches as shown in FIG. 3. It should be appreciated that the arrangement of any stacked composite stiffening patches need not comprise two identical composite stiffening patches. As an example, a composite stiffening patches as shown in FIG. 2A may be located into contact with a composite stiffening patch as shown in FIG. 2C or FIG. 3.

FIG. 5 shows a continuous composite stiffening patch 22, where multiple composite stiffening patches 10 can be cut from the continuous patch 22 and selectively placed onto a vehicle panel surface 12.

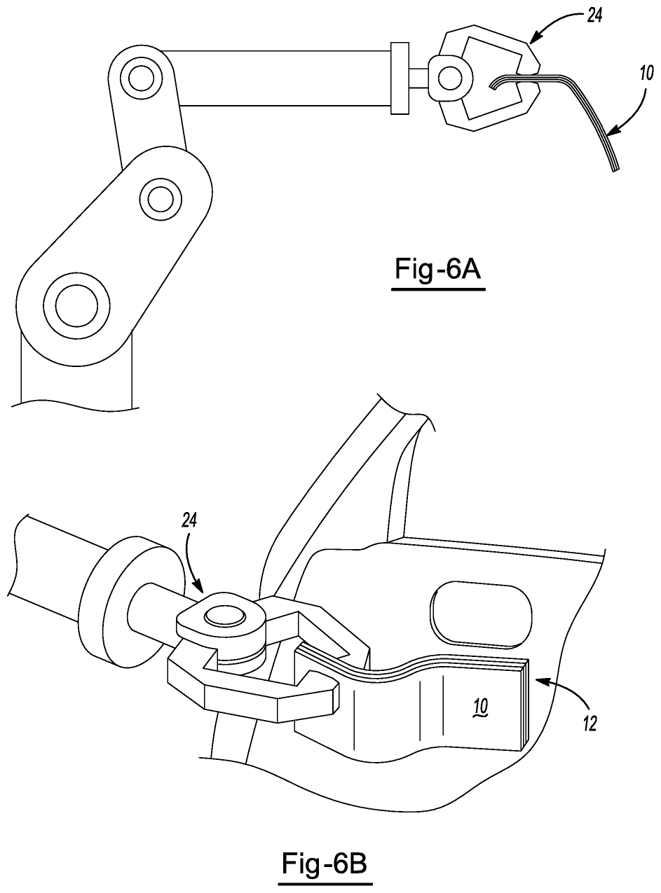

FIG. 6A shows an exemplary robotic arm device 24 holding a composite stiffening patch 10 and FIG. 6B shows the robotic arm device 24 locating the composite stiffening patch 10 onto a vehicle panel surface 12.

It is contemplated that the handling film or layer may be applied to the composite stiffening patch via a number of methods, including but not limited to, lamination process, spray coating, roll coating, brushing, dipping or any combination thereof.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A reinforcing device comprising:
a composite reinforcing patch including:
a first layer comprising a first activatable material that is flexible and tacky in its green state prior to activation;
a second layer comprising a stabilizing material selected from a mesh, a film, a chemical coating, a fibrous or spherical material, or a second activatable material located in planar contact with the activatable material and along the entirety of a first surface of the activatable material, and
an optional third layer comprising a mesh, a film, a chemical coating, second activatable material, or a release paper located in planar contact with the activatable material and along the entirety of a surface of the first layer or second layer;
wherein upon activation of the activatable material, the presence of the second layer, the optional third layer, or both provides dimensional stability to the activatable material and minimizes shrinking of the activatable material.

2. The device of claim 1, including one or more secondary composite reinforcing patches that are located into direct contact with the composite reinforcing patch.

3. The device of claim 2, wherein the one or more secondary composite reinforcing patches including:
a first layer comprising an activatable material;
a second layer comprising a stabilizing material.

4. The device of claim 1, wherein prior to activation of the activatable material, the device is sufficiently flexible to conform to the shape of a vehicle panel.

5. The device of claim 1, wherein after activation of the activatable material, the device continues to conform to the shape of a vehicle panel but is no longer flexible.

6. The device of claim 5, wherein after activation of the activatable material, the device is rigid.

7. The device of claim 1, wherein the device is capable of bending without breaking prior to activation of the activatable material.

8. The device of claim 2, wherein the device will bend under its own weight when held at its end prior to activation of the activatable material.

9. The device of claim 1, wherein the composite reinforcing patch covers a significant portion of an automotive panel (e.g., more than 25%, or more than 50% of the panel).

10. The device of claim 2, wherein the one or more secondary composite reinforcing patches cover only select portions of the composite reinforcing patch where additional reinforcement is required on an automotive panel.

11. The device of claim 5, wherein the activatable material is activated to expand and the volumetric expansion of the activatable material is at least about 100% and less than about 300% relative to its size in the green state.

12. The device of claim 1, wherein the activatable material is a structural adhesive material.

13. (canceled)

14. The device of claim 1, wherein the stabilizing material is an open mesh having an open area of at least 50 percent of a total surface area of the device.

15. The device of claim 14, wherein the stabilizing material is a fibrous material located within and/or onto activatable material.

16. The device of claim 14, wherein the stabilizing material is a material blended into the activatable material and selected from glass fibers, carbon fibers, aramid fibers, glass microspheres, or any combination thereof.

17. The device of claim 1, wherein the second layer or optional third layer is a film is adapted so that polymerization begins to occur at the time the device contacts a surface of a vehicle panel.

18. The device of claim 1, wherein the weight of the composite stiffening patch is sufficiently low to avoid slipping of the device prior to or during activation of the activatable material.

19. The device of claim 1, including the third layer wherein the third layer is a coating located onto the stabilizing layer.

20. The device of claim 19, wherein the coating includes a hydroxide component selected from magnesium hydroxide, aluminum hydroxide, sodium hydroxide, or some combination thereof.

21. The device of claim 19, wherein the coating includes an acetate or acrylate selected from polyvinyl acetate, ethylene vinyl acetate, ethylene methyl acrylate, ethyl acrylate, or combinations thereof.

22-47. (canceled)
